(19) United States
(12) Patent Application Publication
(10) Pub. No.: US 2026/0179447 A1
(43) Pub. Date: Jun. 25, 2026

(54) CODE BASED BONUS WAGERING GAME ENTRY

(71) Applicant: IGT, Las Vegas, NV (US)

(72) Inventors: Sven AURICH, Schwanberg (AT); Michael RUSS, Graz (AT)

(73) Assignee: IGT, Las Vegas, NV (US)

(21) Appl. No.: 18/989,379

(22) Filed: Dec. 20, 2024

(51) Int. Cl. G07F 17/32

(52) U.S. Cl. CPC G07F 17/3258

(57) ABSTRACT

A system includes a processor circuit and a memory coupled to the processor circuit. The memory includes machine-readable instructions that, when executed by the processor circuit, cause the processor circuit to determine a subset of players playing a plurality of primary wagering games at a plurality of gaming devices. The instructions further cause the processor circuit to, for each player of the subset of players, allocate a monetary amount to a bonus game prize pool for a bonus game. The instructions further cause the processor circuit to determine a winning player of the subset of players for the bonus game. The instructions further cause the processor circuit to award a portion of the bonus game prize pool to the winning player.

### BACKGROUND

Embodiments described herein relate to wagering games for use in a gaming environment, such as in a casino environment, and in particular to providing a code based bonus wagering game entry, and related devices, systems, and methods. Casinos and other gaming establishments may provide incentives to players in the form of bonus games, to reward the player for their play, to encourage the player to continue to play, etc. There is a need for features that provide additional incentive and engagement for players.

### BRIEF SUMMARY

According to some embodiments, a system includes a processor circuit and a memory coupled to the processor circuit. The memory includes machine-readable instructions that, when executed by the processor circuit, cause the processor circuit to determine a subset of players playing a plurality of primary wagering games at a plurality of gaming devices. The instructions further cause the processor circuit to, for each player of the subset of players, allocate a monetary amount to a bonus game prize pool for a bonus game. The instructions further cause the processor circuit to determine a winning player of the subset of players for the bonus game. The instructions further cause the processor circuit to award a portion of the bonus game prize pool to the winning player.

According to some embodiments, a gaming device includes a display device, a communication interface, a processor circuit, and a memory coupled to the processor circuit, The memory includes machine-readable instructions that, when executed by the processor circuit, cause the processor circuit to determine a subset of players playing a plurality of primary wagering games at a plurality of gaming devices comprising the gaming device. The instructions further cause the processor circuit to allocate a monetary amount to a bonus game prize pool for a bonus game. The instructions further cause the processor circuit to receive an indication, via the communication interface, that the player at the gaming device is a winning player of the subset of players for the bonus game. The instructions further cause the processor circuit to display, by the display device, an indication that the player is the winning player. The instructions further cause the processor circuit to award a portion of the bonus game prize pool to the player.

According to some embodiments, a method includes determining, by a processor circuit, a subset of players playing a plurality of primary wagering games at a plurality of gaming devices. The method further includes, for each player of the subset of players, allocating, by the processor circuit, a monetary amount to a bonus game prize pool for a bonus game. The method further includes determining, by the processor circuit, a winning player of the subset of players for the bonus game. The method further includes awarding, by a gaming device in communication with the processor circuit, a portion of the bonus game prize pool to the winning player.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 illustrates a plurality of Electronic Gaming Machines (EGMs), arranged in a casino environment for providing a bonus wagering game, according to some embodiments.

FIGS. 4A-4C illustrate a graphical user interface (GUI) for providing a bonus wagering game to a player at an EGM, according to some embodiments.

FIG. 5 is a flowchart illustrating operations of systems/methods of providing a bonus wagering game, according to some embodiments.

### DETAILED DESCRIPTION

Embodiments described herein relate to wagering games for use in a gaming environment, such as in a casino environment, and in particular to providing a code based bonus wagering game entry, and related devices, systems, and methods.

According to some embodiments, a group of players, such as a group of friends visiting a casino, may register as a group when entering the casino. The group may receive a unique code, such as a QR code, which may be printed on a redeemable ticket, delivered to one or more mobile devices, delivered to one or more gaming devices, etc., as desired. In some examples, wagering game play by the group may be associated with a shared pot and/or jackpot, such that only players associated with the unique code may be eligible to win some or all of the share pot and/or jackpot. In some examples, a portion, e.g., set amount and/or percentage, of primary game wagers and/or primary game wins may be allocated to the shared pot and/or jackpot.

In some examples, the unique code may enable sharing, e.g., livestreaming, recording, etc., of game play with other players in the group, and or other players or observers. For example, an observer who wants to follow a particular player's gameplay may do so by scanning a unique code with the observer's mobile device, which may enable viewing of a livestream of the player's gameplay. In some examples, a unique code may be shared, e.g., via social media, email, etc., by the player, observer, or other individual, as desired.

In some examples, a game element of a wagering game at the gaming device, such as a bonus symbol, may include a unique code, such as a QR code, that may be scanned by a player's mobile device. The code may enable a bonus game, bonus feature, and/or some other benefit for the player via the player's mobile device. For example, the code may be redeemed for a bonus coin or other game element that can be used in a primary wagering game and/or bonus wagering game to enhance a game award therein.

In some examples, a unique code, such as a QR code, may enable a tournament style game in a casino or other location. For example, a number of gaming devices on a casino floor may display a code, which may be scanned by a player's mobile device and/or otherwise accepted or redeemed by a number of players. In some examples, tournament entries may be limited, with the players scanning the code the fastest being eligible for entry into the tournament. In some examples, the code may also include tournament information, such as a start time, which may be integrated into other functions of the player's mobile device, such as automatically creating a calendar entry with the tournament information.

In some examples, a number of game elements, such as slot symbols for example, may include a code and/or a portion of a code, such as a QR code. In some examples, a particular sequence of game symbols may result in a corresponding unique sequence of code portions being displayed, e.g., a number of adjacent code portions in a particular order, which combine to form a unique code. In some examples, a player may move the code portions via a GUI of the gaming device, e.g., dragging the code portions to specific locations to rearrange the pattern and/or sequence, to create different unique codes with different properties and/or associated awards and/or benefits. For example, a three dimensional puzzle box may be displayed, with portions of the box being rotatable to rearrange portions of the box to form unique codes and code sequences. In some examples, a player may select a subset of code portions in a particular sequence to create different unique codes. In some examples, a random picture and/or pattern, e.g., in a 100×100 pixel area of a display, may be generated, with some or all of the randomly generated pictures and/or patterns including machine readable codes that may be scanned to redeem a particular prize, benefit, etc. In some examples, a player may draw their own picture and/or pattern, with certain features and/or patterns within certain pictures including machine readable codes associated with prizes and/or benefits.

In some examples, the codes and/or code portions may only be visible for a limited time, and/or may be periodically displayed. For example, different code portions may be displayed periodically at different rates, such that a large number of different combinations of code portions are displayed at different times. In some examples, code portions may continuously change in real time, such that the completed code also dynamically changes in real time.

In some examples, the code portions may be scanned over time, with the player collecting sufficient code portions during different game instances and/or sessions to generate a complete code. In some examples, a game and/or gaming device may store collected code portions such that the player can access, discard, sell, and/or trade code portions over time, which may be indefinitely, and/or within a predetermined time period, as desired. At the end of the game session or at a later time, the collected code portions may be displayed together, such that the completed code may be scanned without interrupting the previous game session or other game play.

In some examples, code portions may be displayed in a portion of the game play screen, such that progress toward building a completed code can be viewed during game play over time. In some examples, the collected code portions may be persistent across game instances, game sessions, and/or gaming devices. For example, a player may collect code portions from several different gaming device types and/or wagering games to form a completed code. The award and/or benefit (and/or potential ranges thereof) may be displayed in advance, and/or may be hidden until the code is completed and/or redeemed by the player. In some examples, continued collection of code portions may include a risk of loss of the code portions. For examples, a player may scan a partially completed code to redeem a reduced award, or may attempt to collect more code portions at the risk of a game event destroying and/or voiding some or all of the collected code portions.

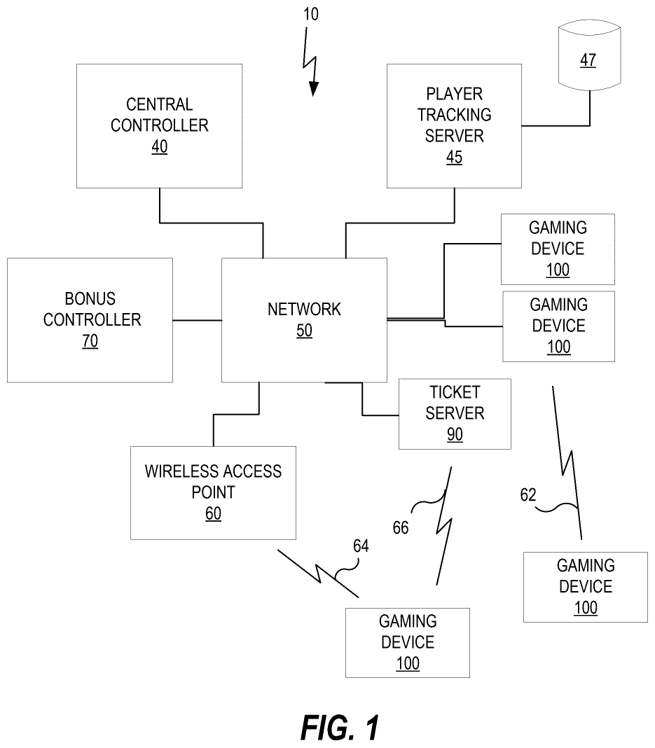

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A bonus controller 70 may communicate with the central controller 40, player tracking server 45, and other components of the system 10 to track, manage, and provide bonuses, such as return play bonuses described herein, to players. In some examples, the bonus controller 70 may be a standalone component, or may be incorporated into other components of the system 10, such as the central controller 40, etc.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

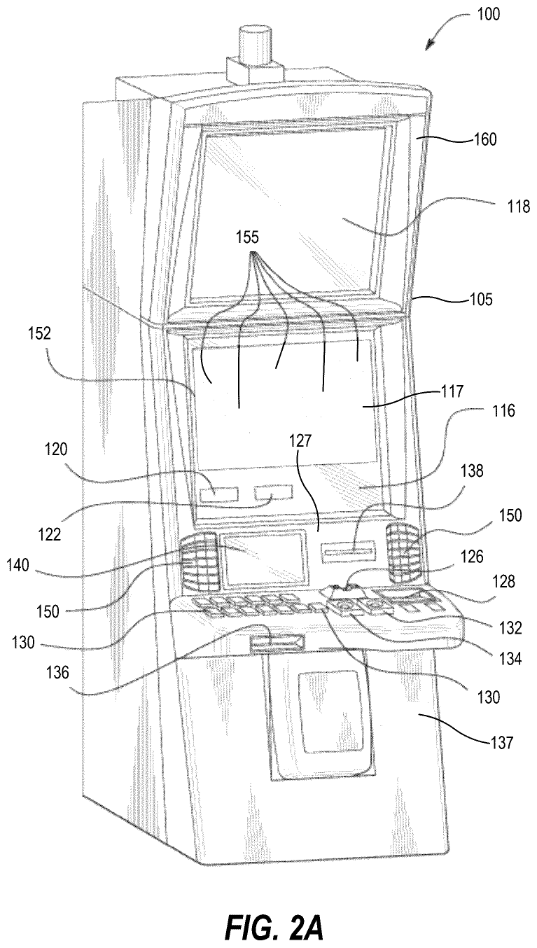

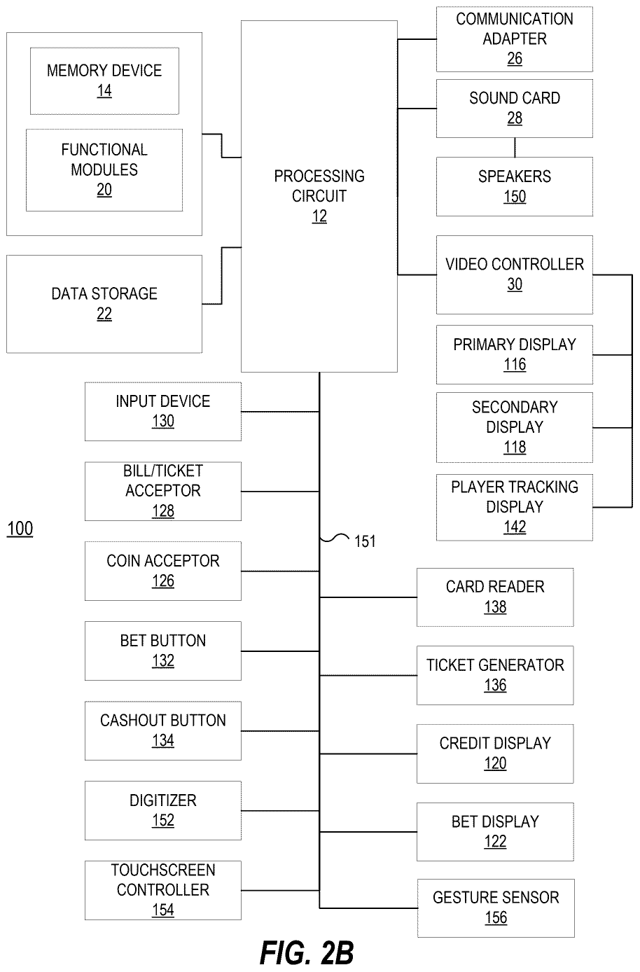

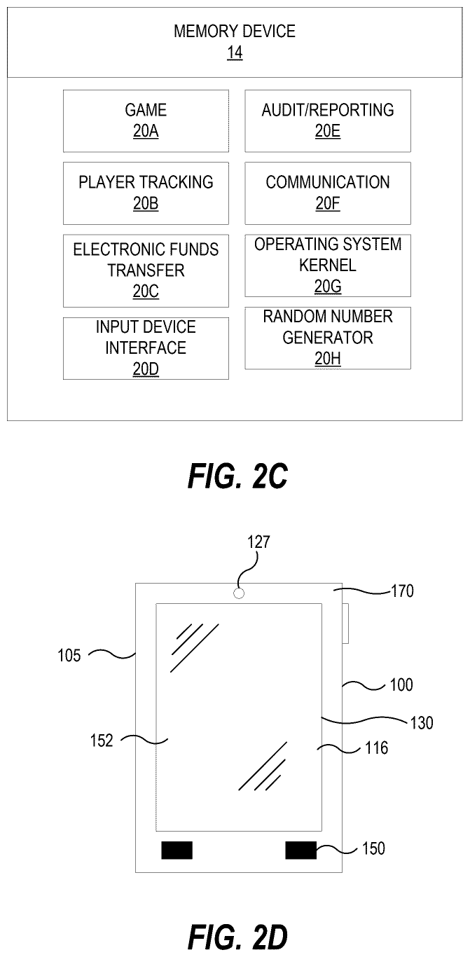

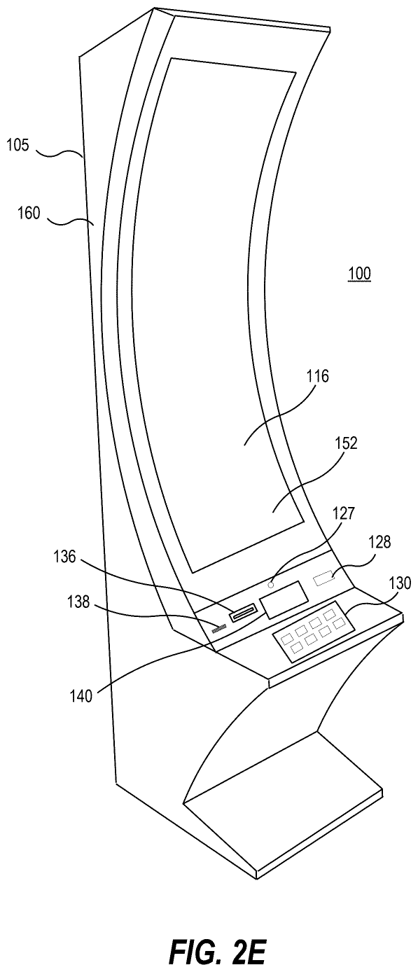

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

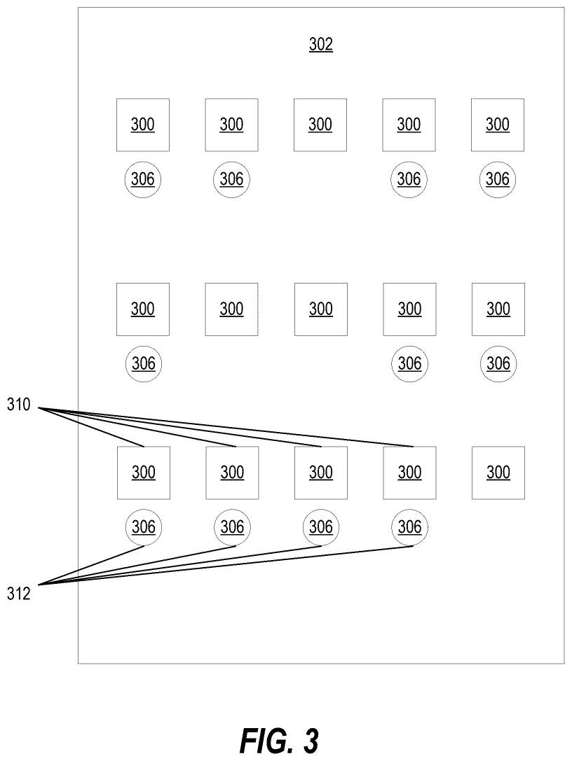

FIG. 3 illustrates a plurality of EGMs 300 arranged in a casino environment 302, e.g., on a casino floor. In this example, the EGMs 300 are in communication with a system, such as the gaming system 10 of FIG. 1, but it should be understood that the EGMs 300 may be in communication with each other directly or indirectly, e.g., via a local or cloud-based system, as desired. In this example, a plurality of players 306 may be playing primary wagering games at some or all of the plurality of EGMs 300.

In this example, the EGMs 300 and/or system may determine a subset of players 308 playing primary wagering games as a subset of EGMs 310. In this example, determining the subset of players 308 may include a determination that each player of the subset of players 308 has submitted a bonus game entry. For example, the submission of a game entry may include transmission of a game entry code from a player device, e.g., a mobile computing device, associated with the EGM. In another example, submission of a game entry may include optically scanning, by an image capture device of the player device, e.g., a camera, a graphical code being displayed by the EGM, with the game entry code being determined by the EGM based on the scanned graphical code. In this example, the determination of the subset of players 308 is further based on the players all playing at an EGM 300 in the same casino 302, on a group of casinos (e.g., within a brand network or operator network), and/or at a particular subset of EGMs within the casino 302, etc., as desired.

In this example, the EGMs 300 and/or system may, for each player of the subset of players 308, allocate a monetary amount to a bonus game prize pool for a bonus game. For example, the allocation of the monetary amount may include an allocation of a portion of a one or more primary game wagers for the primary games being played at the subset of EGMs 310 by the subset of players 308. In another example, the allocation of the monetary amount may include an allocation of a portion of one or more primary game awards for the primary games being played at the subset of EGMs 310 by the subset of players 308. Alternatively, or in addition, the allocation of the monetary amount may be made by an operator of the plurality of EGMs 300, e.g., as a promotion or incentive provided by the operator of the casino 302 to encourage game play.

In this example, the EGMs 300 and/or system may determine a winning player 312 of the subset of players 308 for the bonus game, and may award a portion of the bonus game prize pool to the winning player 312. In some examples, the entire bonus game prize pool may be awarded to the winning player, e.g., as a progressive jackpot or other type of bonus game jackpot.

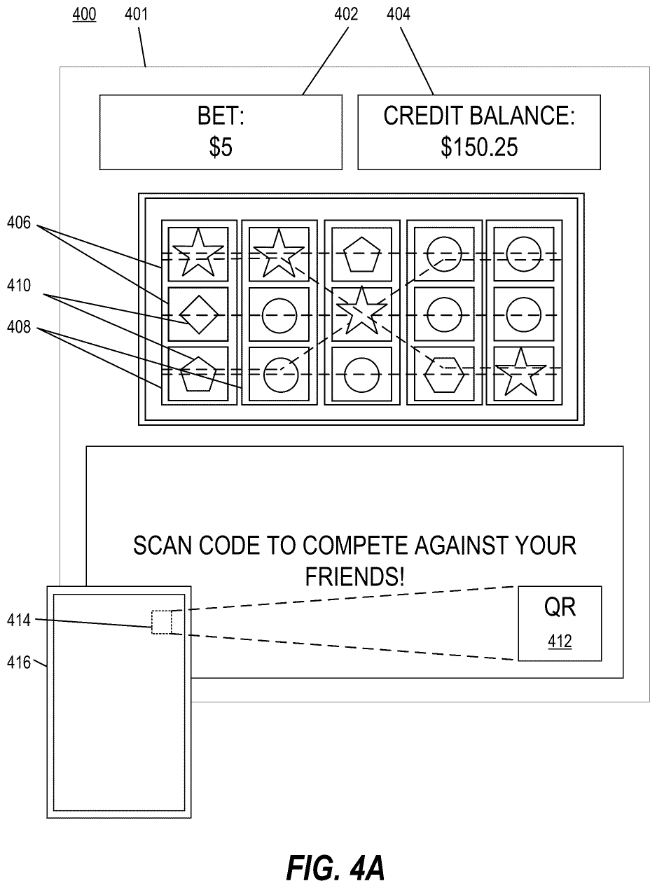

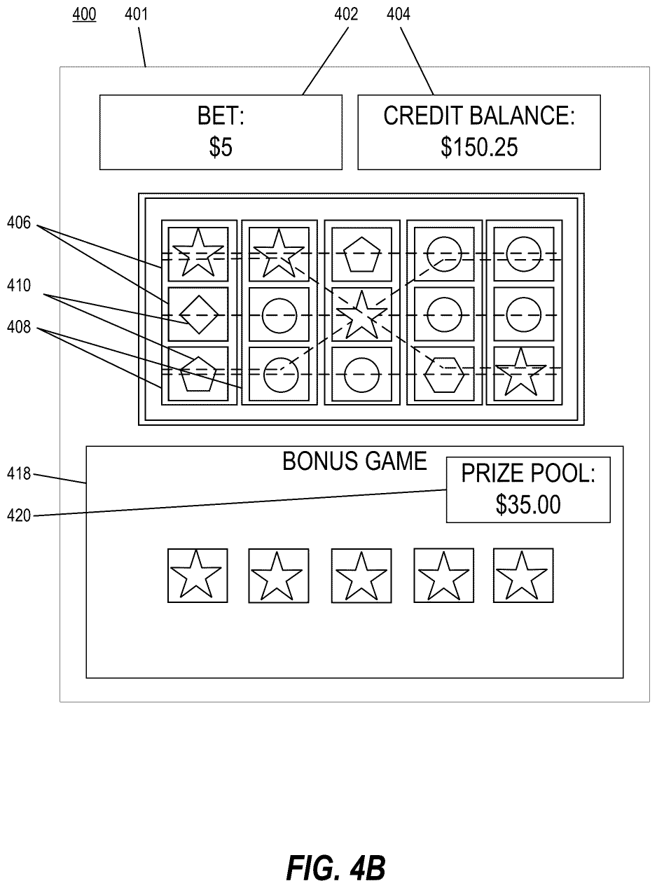

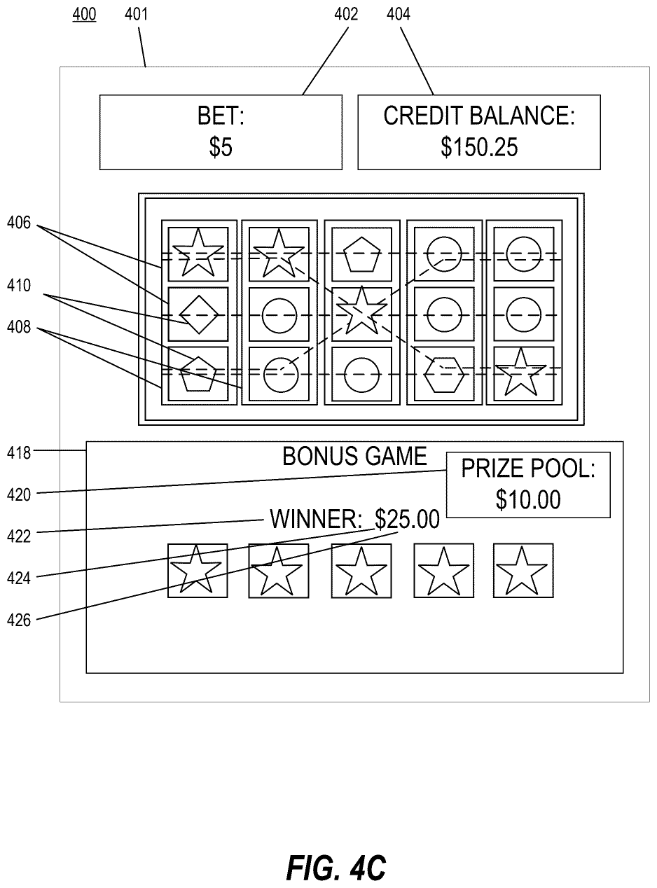

Referring now to FIGS. 4A-4C, a graphical user interface (GUI) 401 for providing a bonus game to a player at an EGM 400 is illustrated, according to some embodiments. As shown by FIG. 4A, the GUI 401 may include a bet button 402, a credit meter 404, and a plurality of game elements 406 for a primary wagering game, such as a plurality of slot reels 408 and slot symbols 410 for example.

In this example, the GUI 401 may further include a graphical code 412 that may be optically scanned by an image capture device 414 of a player device 416, e.g., by a camera of a mobile computing device. In response to optically scanning the graphical code 412, the player device 416 may determine and/or transmit a game entry code for a bonus wagering game to the EGM 400 and/or to a central server in communication with the EGM 400 and/or other network.

As shown by FIG. 4B, based on the transmission of the game entry code by the player device 416 and other player devices associated with players at different EGMs, a bonus wagering game 418 may be initiated, and monetary amounts, e.g., from primary game wagers, primary game winnings, operator contributions, etc., may be allocated to a bonus game prize pool 420.

As shown by FIG. 4C, the EGM 400 may receive an indication that the player at the EGM 400 is a winning player for the bonus wagering game 418. Based on receipt of the indication, the GUI 401 may display an indication 422 that the player is the winning player, and may award a portion 424 of the bonus game prize pool 420 to the player, e.g., as a bonus game award 426.

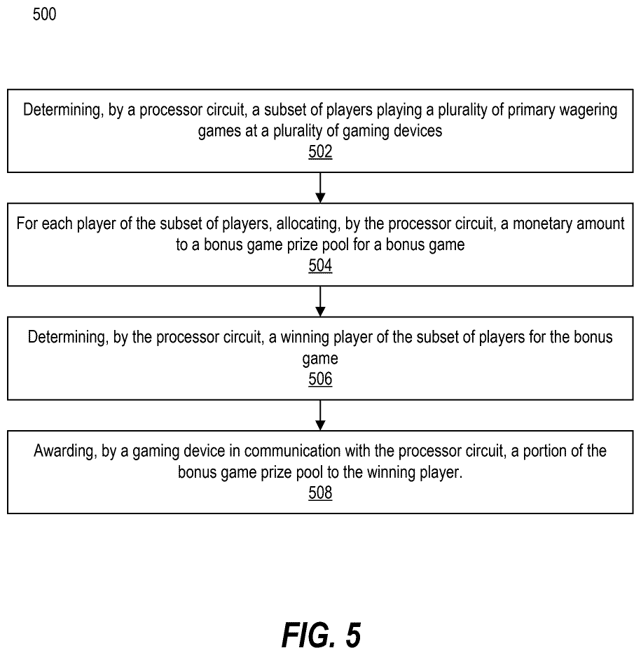

FIG. 5 is a flowchart illustrating operations 500 of systems/methods of providing a bonus wagering game, according to some embodiments. The operations 500 may be performed by one or more processor circuits of one or more computing devices, such as any of the computing devices described herein, for example. The operations 500 may include determining, by a processor circuit, a subset of players playing a plurality of primary wagering games at a plurality of gaming devices (Block 502). The operations 500 may further include, for each player of the subset of players, allocating, by the processor circuit, a monetary amount to a bonus game prize pool for a bonus game (Block 504). The operations 500 may further include determining, by the processor circuit, a winning player of the subset of players for the bonus game (Block 506). The operations 500 may further include awarding, by a gaming device in communication with the processor circuit, a portion of the bonus game prize pool to the winning player (Block 508).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet, or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
determine a subset of players playing a plurality of primary wagering games at a plurality of gaming devices;
for each player of the subset of players, allocate a monetary amount to a bonus game prize pool for a bonus game;
determine a winning player of the subset of players for the bonus game; and
award a portion of the bonus game prize pool to the winning player.

2. The system of claim 1, wherein the determination of the subset of players comprises:
a determination that each player of the subset of players has submitted a bonus game entry.

3. The system of claim 2, wherein submission of a game entry comprises:
transmission of a game entry code from a player device associated with the device.

4. The system of claim 3, wherein submission of a game entry comprises:
optically scanning, by an image capture device of the player device, a graphical code being displayed by the gaming device; and
determining, based on the scanned graphical code, the game entry code.

5. The system of claim 1, wherein the determination of the subset of players comprises:
a determination that each player of the subset of players is playing at a gaming device in a same casino.

6. The system of claim 1, wherein the allocation of the monetary amount comprises:
an allocation of a portion of a plurality of primary game wagers for a plurality of primary games being played at the plurality of gaming devices by the subset of players.

7. The system of claim 1, wherein the allocation of the monetary amount comprises:
an allocation of a portion of a plurality of primary game awards for a plurality of primary games being played at the plurality of gaming devices by the subset of players.

8. The system of claim 1, wherein the allocation of the monetary amount comprises:
an allocation of the monetary amount by an operator of the plurality of gaming devices.

9. The system of claim 1, wherein the award of a portion of the bonus game prize pool to the winning player comprises an award of the entire bonus game prize pool to the winning player.

10. A gaming device comprising:
a display device;
a communication interface;
a processor circuit; and
a memory coupled to the processor circuit, the memory comprising machine-readable instructions that, when executed by the processor circuit, cause the processor circuit to:
determine a subset of players playing a plurality of primary wagering games at a plurality of gaming devices comprising the gaming device;
allocate a monetary amount to a bonus game prize pool for a bonus game;
receive an indication, via the communication interface, that the player at the gaming device is a winning player of the subset of players for the bonus game; and
display, by the display device, an indication that the player is the winning player; and
award a portion of the bonus game prize pool to the player.

11. The gaming device of claim 10, wherein the determination of the subset of players comprises:
a determination that each player of the subset of players has submitted a bonus game entry.

12. The gaming device of claim 11, wherein submission of a game entry comprises:
transmission of a game entry code from a player device associated with the device.

13. The gaming device of claim 12, wherein submission of a game entry comprises:
optically scanning, by an image capture device of the player device, a graphical code being displayed by the gaming device; and
determining, based on the scanned graphical code, the game entry code.

14. The gaming device of claim 10, wherein the determination of the subset of players comprises:
a determination that each player of the subset of players is playing at a gaming device in a same casino.

15. The gaming device of claim 10, wherein the allocation of the monetary amount comprises:
an allocation of a portion of a primary game wager for a primary game being played at the gaming device by the player.

16. The gaming device of claim 10, wherein the allocation of the monetary amount comprises:
an allocation of a portion of a primary game award for a primary game being played at the gaming device by the player.

17. The gaming device of claim 10, wherein the allocation of the monetary amount comprises:
an allocation of the monetary amount by an operator of the plurality of gaming devices.

18. The gaming device of claim 10, wherein the award of a portion of the bonus game prize pool to the winning player comprises an award of the entire bonus game prize pool to the winning player.

19. A method comprising:
determining, by a processor circuit, a subset of players playing a plurality of primary wagering games at a plurality of gaming devices;
for each player of the subset of players, allocating, by the processor circuit, a monetary amount to a bonus game prize pool for a bonus game;
determining, by the processor circuit, a winning player of the subset of players for the bonus game; and
awarding, by a gaming device in communication with the processor circuit, a portion of the bonus game prize pool to the winning player.

20. The method of claim 19, wherein determining the subset of players further comprises determining that each player of the subset of players has submitted a bonus game entry, and wherein submission of a game entry comprises:
optically scanning, by an image capture device of a player device associated with the gaming device, a graphical code being displayed by the gaming device;
determining, based on the scanned graphical code, the game entry code; and
transmitting, by the player device, the game entry code to the processor circuit.
